(19) United States
(12) Patent Application Publication
(10) Pub. No.: US 2014/0118725 A1
(43) Pub. Date: May 1, 2014

(54) SUPPORTING DEVICE AND SYSTEM FOR DETECTING OPTICAL COUPLING LENS

(71) Applicant: HON HAI PRECISION INDUSTRY CO., LTD., New Taipei (TW)

(72) Inventor: CHANG-WEI KUO, New Taipei (TW)

(73) Assignee: HON HAI PRECISION INDUSTRY CO., LTD., New Taipei (TW)

(21) Appl. No.: 13/851,980

(22) Filed: Mar. 28, 2013

(30) Foreign Application Priority Data
Oct. 25, 2012 (TW) 101139418

(51) Int. Cl. G01M 11/02; B25B 11/00

(52) U.S. Cl. CPC G01M 11/0214; B25B 11/00; G01M 11/0242
USPC 356/124; 269/216

(57) ABSTRACT

A device for supporting an optical coupling lens for testing includes a platform, a first contacting member fixedly mounted on the platform, a second contacting member moveably mounted on the platform, and a pressing member positioned on the platform. The platform defines a supporting recess which is configured for supporting the optical coupling lens firmly and in a particular orientation during testing, by means of spring pressure.

### BACKGROUND

1. Technical Field

The present disclosure relates to a supporting device and a system for detecting an optical coupling lens using the supporting device.

2. Description of Related Art

An optical coupling lens is molded using an injection molding die. After the optical coupling is molded, the optical coupling lens needs to be tested. During the test process, the optical coupling lens is placed on a horizontal supporting surface of a supporting device, and the optical coupling lens to is perpendicular to the supporting surface. However, the optical coupling lens is very light and easily moved if an external force is applied to the optical coupling lens. This adversely influences the test accuracy.

Therefore, it is desirable to provide a supporting device and a system for detecting an optical coupling lens and holding it firmly in one orientation which can overcome or alleviate the above-mentioned problems.

### BRIEF DESCRIPTION OF THE DRAWINGS

FIG. 1 is a schematic, isometric view of a supporting device, according to a first exemplary embodiment.

FIG. 2 is an exploded view of the supporting device of FIG. 1.

FIG. 3 is similar to FIG. 2, but viewed from another angle.

FIG. 4 is similar to FIG. 1, but viewed from another angle.

FIG. 5 is a view showing the supporting device of FIG. 1 supporting an optical coupling lens.

FIG. 6 is an enlarged sectional view of the items in FIG. 5, taken along a line VI-VI.

FIG. 7 is an exploded view of a supporting device, according to a second exemplary embodiment.

FIG. 8 is a schematic, isometric view of a supporting device, according to a third exemplary embodiment.

FIG. 9 is a schematic, isometric view of a system for detecting an optical coupling lens, according to a fourth exemplary embodiment.

### DETAILED DESCRIPTION

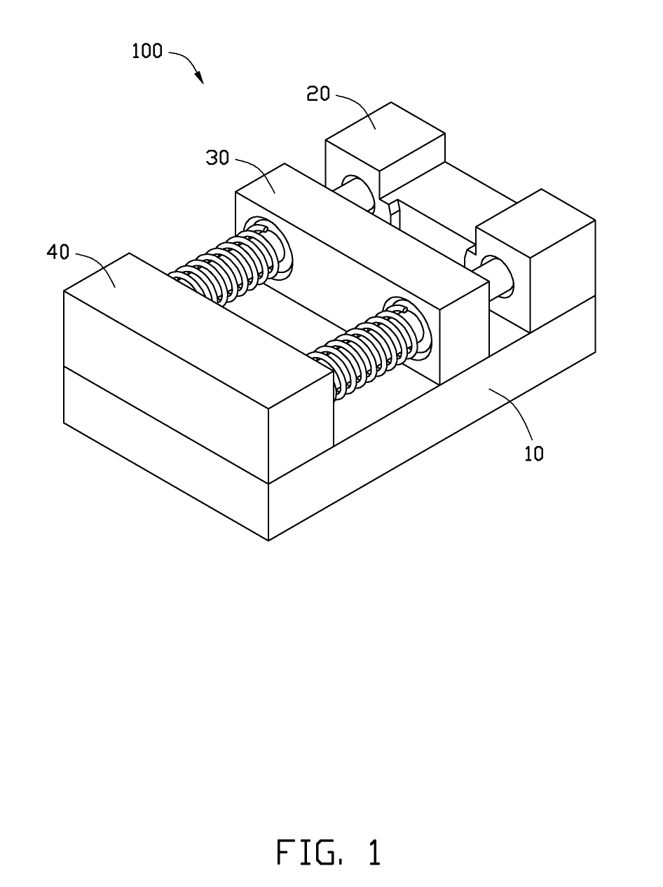

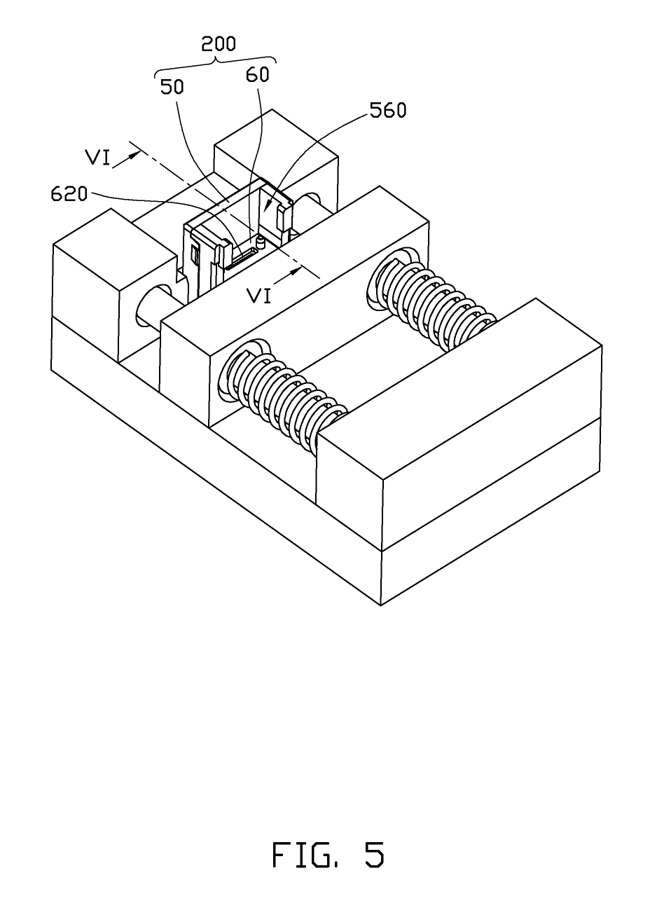

Referring to FIG. 1, a supporting device 100, according to a first exemplary embodiment, includes a platform 10, a first contacting member 20, a second contacting member 30, and a pressing member 40. The supporting device 100 supports an optical coupling lens 200 (shown in FIG. 5) as it is being tested.

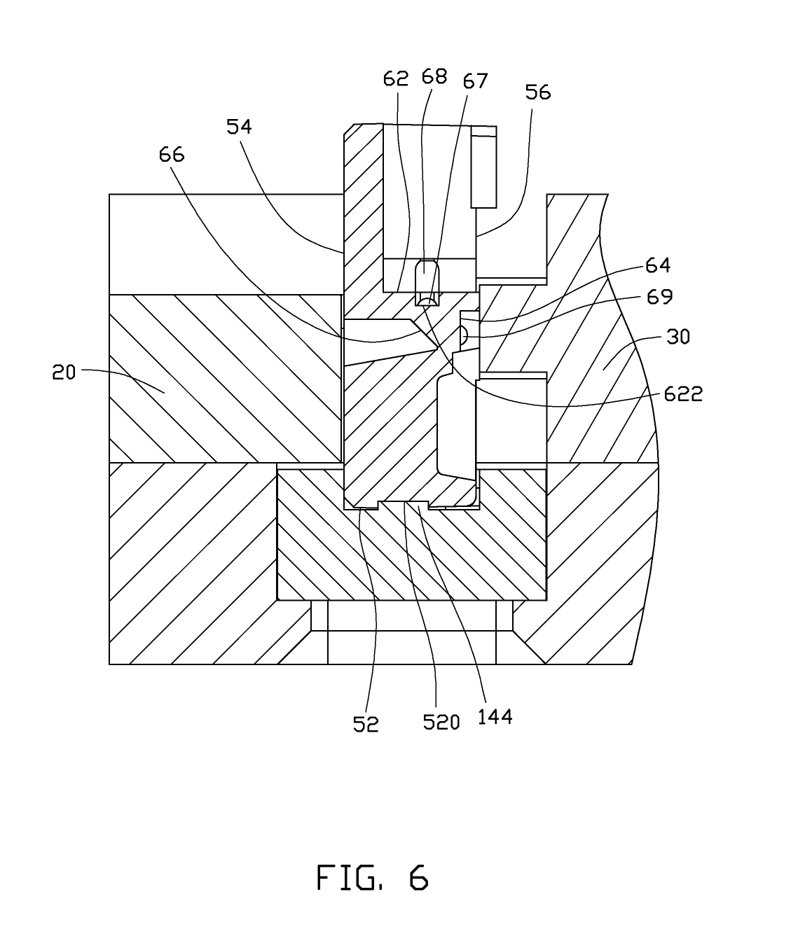

Referring to FIGS. 5-6, the optical coupling lens 200 includes a housing 50 and a lens block 60 positioned in the housing 50. The housing 50 and the lens block 60 may be integral.

The housing 50 includes a bottom wall 52, a first sidewall 54, and a second sidewall 56. The bottom wall 52 defines a receiving recess 520 in a central portion thereof. The receiving recess 520 has a horizontal bottom surface. The first sidewall 54 and the second sidewall 56 are positioned at opposite sides of the housing 50 and are perpendicular to the bottom wall 52. The second sidewall 56 defines a cavity 560, which does not pass through the bottom wall 52.

The lens block 60 is positioned in the cavity 560 and includes a coupling surface 62, a light incident surface 64, a reflection surface 66, a number of first optical lenses 67, two posts 68, and a number of second optical lenses 69.

The coupling surface 62 defines a rectangular groove 620. The groove 620 includes a light output surface 622. The light output surface 622 is positioned in a bottom of the groove 620 and is parallel to the coupling surface 62. The coupling surface 62 and the light output surface 622 are perpendicular to the light incident surface 64 and parallel to the bottom surface of the receiving groove 520. The reflection surface 66 is obliquely positioned between the light incident surface 64 and the light output surface 622. The posts 68 perpendicularly extend from the coupling surface 62 and flank the groove 620. The first optical lenses 67 are formed on the light output surface 622. The first optical lenses 67 are arranged in a line along a direction from one of the two posts 68 to the other of the two posts 68. The second optical lenses 69 are formed on the light incident surface 64 and arranged in a one-to-one line corresponding to the first optical lenses 67. The reflection surface 66 is configured to reflect light passing through a second optical lens 69 toward a corresponding first optical lens 67, and to reflect light passing through a first optical lens 67 toward a corresponding second optical lens 69.

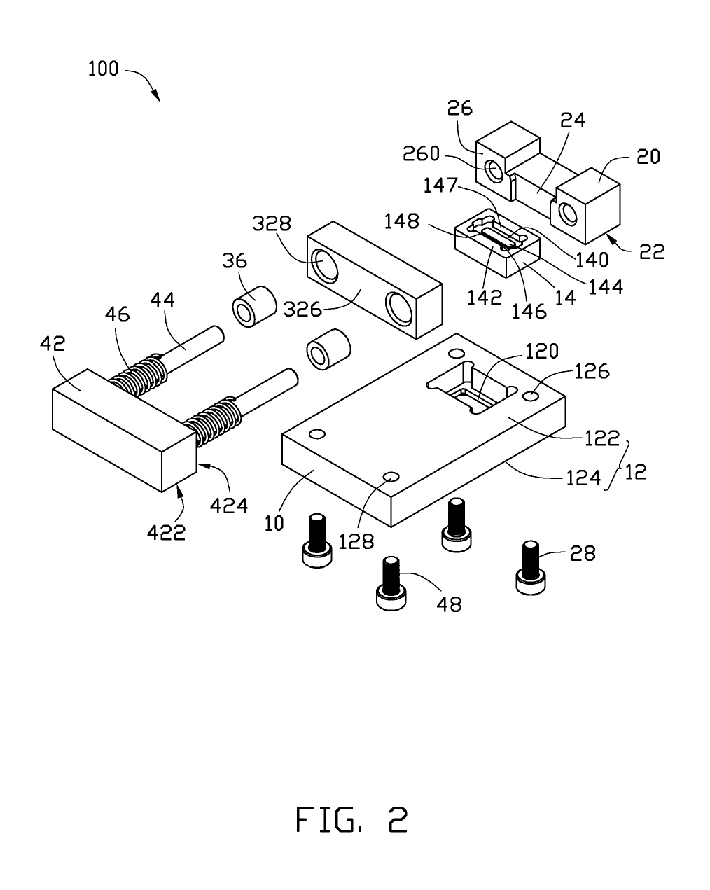

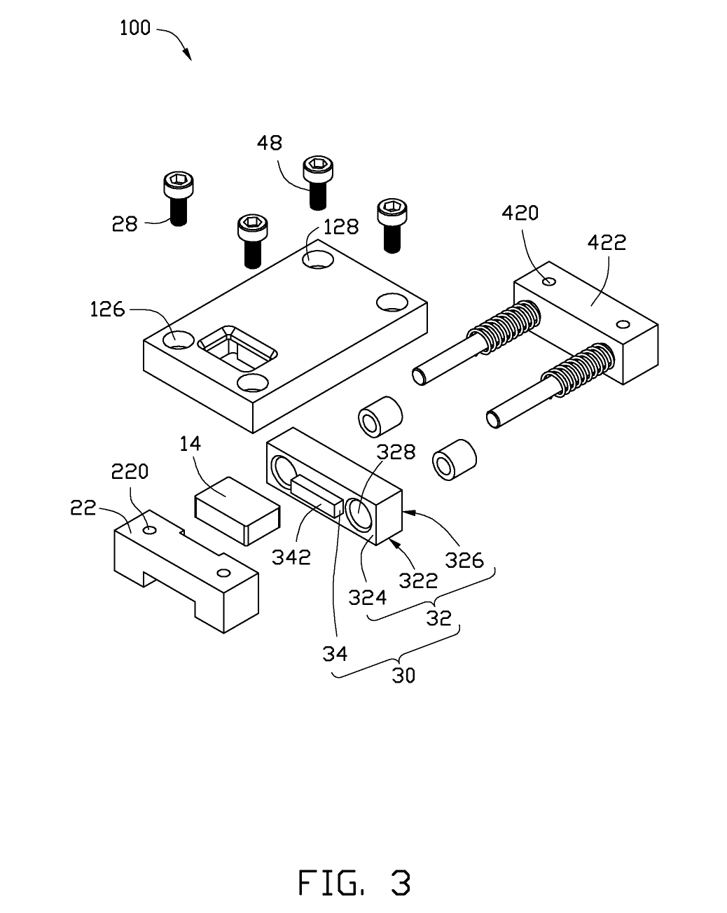

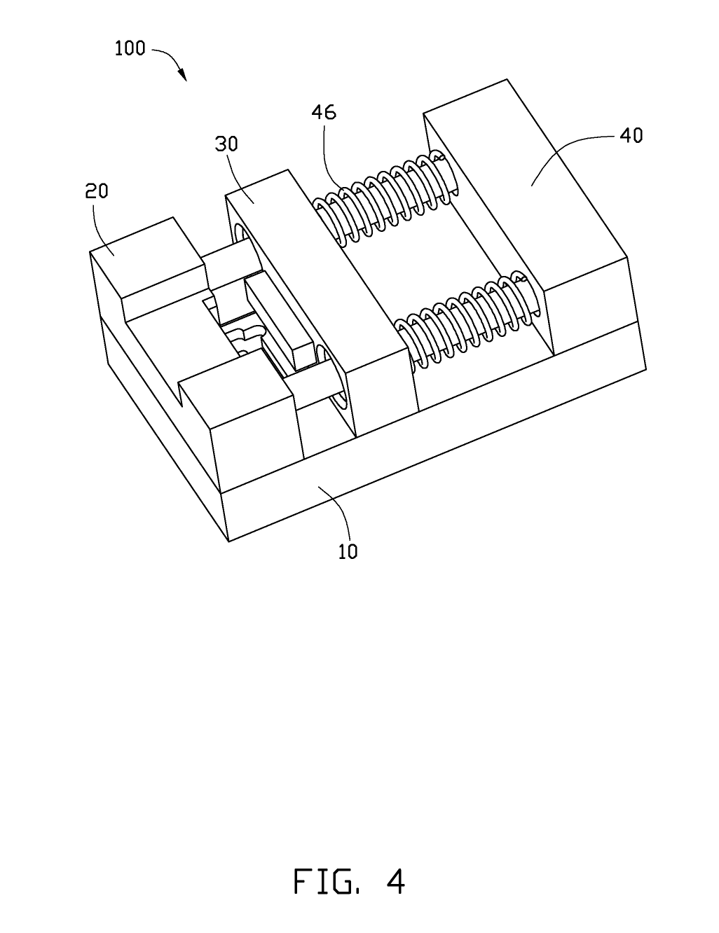

Referring to FIGS. 1-4, the platform 10 includes a main body 12 and a support block 14.

The main body 12 includes an upper surface 122 and a lower surface 124. The upper surface 122 and the lower surface 124 are positioned at opposite sides of the main body 12, and the upper surface 122 is parallel to the lower surface 124. The main body 12 defines a through hole 120, two first bores 126, and two second bores 128. The through hole 120 passes through the upper surface 122 and the lower surface 124. The first bores 126 and the second bores 128 pass through the upper surface 122 and the lower surface 124. The first bores 126 are spaced from each other and are arranged at a side of the through hole 120. The second bores 128 are spaced from each other and are arranged at opposing sides of the through hole 120. In this embodiment, the through hole 120 is substantially rectangular, and the first bores 126 and the second bores 128 are substantially circular.

The supporting block 14 is substantially a rectangular plate and fixedly mounted in the through hole 120. The supporting block 14 includes a supporting surface 142 and a protrusion 144. The supporting surface 142 is coplanar with the upper surface 122 and defines a supporting recess 140. The supporting recess 140 is substantially rectangular and includes a bottom 146, a first inner side surface 147, and a second inner side surface 148. The first inner side surface 147 and the second inner side surface 148 are perpendicular to the bottom 146 and are parallel to each other. The protrusion 144 extends from the bottom 146 and has a horizontal top surface. In this embodiment, the supporting block 14 is made of acrylic material.

The first contacting member 20 is fixedly mounted on the platform 10 and is adjacent to the first inner side surface 147. In detail, the first contacting member 20 includes a first bottom surface 22, a first contacting surface 24, and two connecting surfaces 26. The first bottom surface 22 contacts the upper surface 122. The first contacting surface 24 perpendicularly extends from the first bottom surface 22. The two connecting surfaces 26 perpendicularly extend from the first bottom surface 22 and are arranged at opposite sides of the first contacting surface 24. The first contacting surface 24 is recessed relative to the two connecting surfaces 26. Each of the connecting surfaces 26 defines a blind hole 260.

In this embodiment, the first contacting member 20 is screwed to the platform 10. In detail, the first bottom surface 22 defines two first threaded holes 220 corresponding to the first bores 126. Two bolts 28 pass through the first bores 126 and engage in the first threaded holes 220, and the first contacting member 20 is thereby mounted on the upper surface 122. The first contacting member 20 may be mounted on the upper surface 122 with adhesive, in another embodiment.

The second contacting member 30 is moveably mounted on the platform 10 and is adjacent to the second inner side surface 148. In detail, the second contacting member 30 includes a body portion 32, a contacting portion 34, and two sleeves 36. The body portion 32 is substantially a cuboid and includes a second bottom surface 322, a first side surface 324, and a second side surface 326. The second bottom surface 322 contacts the upper surface 122. The first side surface 324 and the second side surface 326 perpendicularly extend from the second bottom surface 322 and are parallel to each other. The first side surface 324 is nearer to the second inner side surface 148 than the second side surface 326 is. The body portion 32 defines two receiving holes 328. The receiving holes 328 pass through the first side surface 324 and the second side surface 326. The contacting portion 34 perpendicularly extends from the first side surface 324 and is sandwiched between the two receiving holes 328. The contacting portion 34 has a second contacting surface 342 facing away from the first side surface 324. The sleeves 36 are fixedly mounted in the receiving holes 328. In this embodiment, the second contacting surface 342 is parallel to the first side surface 324.

The pressing member 40 includes a stationary portion 42, two guide poles 44, and two resilient portions 46. The stationary portion 42 is substantially a cuboid and fixedly mounted on the upper surface 122. The stationary portion 42 includes a third bottom surface 422 and a fixing surface 424. The third bottom surface 422 contacts the upper surface 122. The fixing surface 424 is parallel to and faces the second side surface 326. The guide poles 44 correspond to the two sleeves 36 and the two blind holes 260. One end of each of the guide poles 44 is fixed to the fixing surface 424, and the other end of each of the guide poles 44 passes through a sleeve 36 and engages in a blind hole 260. The resilient portions 46 sleeve on the guide poles 44 and are sandwiched between the stationary portion 42 and the second side surface 326. One end of each of the resilient portions 46 is fixed to the fixing surface 424, and the other end of each of the resilient portions 46 is fixed to a sleeve 36. In this embodiment, the resilient portions 46 are compression springs.

The stationary portion 42 is screwed to the platform 10. In detail, the third bottom surface 422 defines two second threaded holes 420 corresponding to the two second bores 128. Two bolts 48 pass through the second bores 128 and engage in the second threaded holes 420, and the stationary portion 42 is thereby mounted on the upper surface 122. The stationary portion 42 may be mounted on the upper surface 122 with adhesive, in another embodiment.

Referring to FIG. 6, when the supporting device 100 is not supporting the optical coupling lens 200 (shown in FIG. 5), the resilient portions 46 are at rest. In other words, the resilient portions 46 are not being pulled and are not being compressed.

Referring to FIGS. 5-6, when the optical coupling lens 200 is to be supported by the supporting device 100, first, an external force is applied to the second contacting member 30. The external force moves the second contacting member 30 along the guide poles 44 toward the stationary portion 42. Thus, a space for easily placing the optical coupling lens 200 in the supporting recess 140 is generated. In this situation, the resilient portions 46 are compressed. Second, the optical coupling lens 200 is placed in the supporting recess 140. In detail, the protrusion 144 engages in the receiving recess 520, and the horizontal bottom surface of the receiving recess 520 contacts the horizontal top surface of the protrusion 144. The first sidewall 54 contacts the first inner side surface 147, and the second sidewall 56 contacts the second inner side surface 148. Third, the external force is released, and the resilient portions 46 pull the second contacting member 30 to make contact with the optical coupling lens 200. In particular, the second contacting surface 342 makes contact with and abuts the second sidewall 56. Thereby, the optical coupling lens 200 is fixedly supported on the platform 10, and the housing 50 is perpendicular to the platform 10. The optical coupling lens 200 is restricted by the first contacting member 20 and the second contacting member 30, and is firmly held in place notwithstanding an external force applied to the optical coupling lens 200. As a result, the precision and repeatability of the test accuracy is increased.

In addition, the optical coupling lens 200 is kept vertical as the horizontal bottom surface of the receiving recess 520 is supported on the horizontal top surface of the protrusion 144b. That is, the coupling surface 62 is horizontal even though the bottom wall 52 is inclined as the injection molding die is designed to have a draft angle. This further increases the test accuracy.

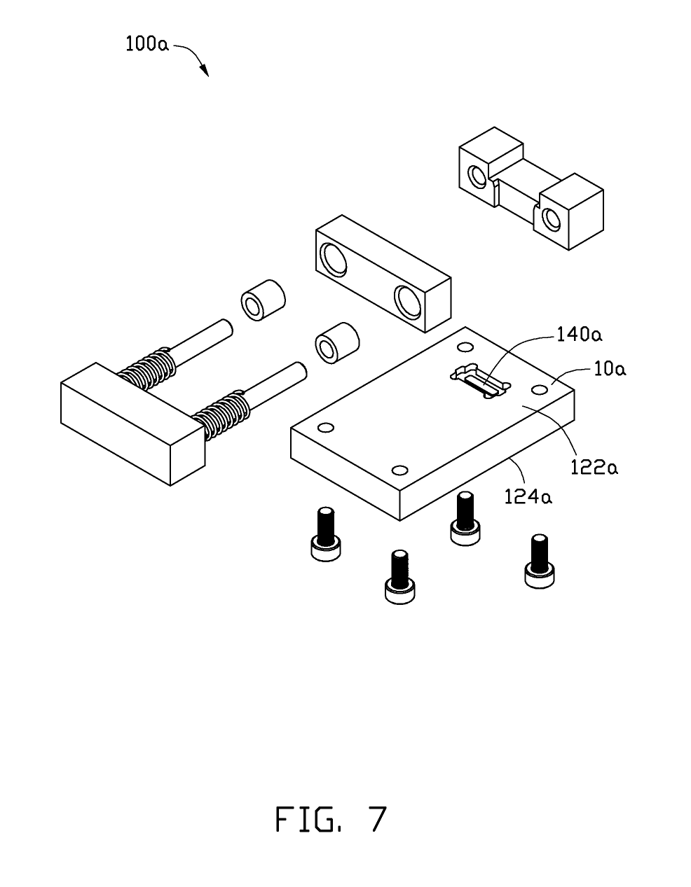

Referring to FIG. 7, a supporting device 100a, according to a second exemplary embodiment is shown. The differences between the supporting device 100a and the supporting device 100 are that a platform 10a is a plate and the supporting block is omitted. Accordingly, a supporting recess 140a is defined in an upper surface 122a.

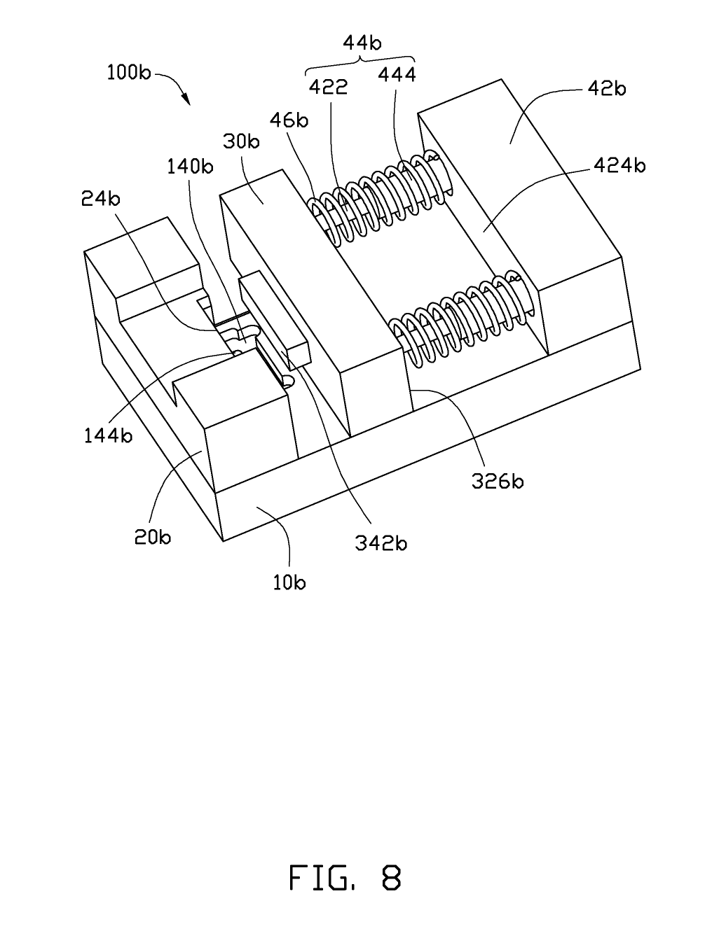

Referring to FIG. 8, a supporting device 100b, according to a third exemplary embodiment, is shown. The supporting device 100b includes two telescopic poles 44b instead of the guide poles 44 of the supporting device 100. Each of the telescopic poles 44b includes a receiving portion 442 and a telescopic portion 444. The telescopic portion 444 can be entirely received in the receiving portion 442, and the telescopic portion 444 can stretch out from the receiving portion 442. One end of each of the telescopic poles 44b is fixed to the fixing surface 424b, and the other end of each of the telescopic poles 44b is fixed to the second side surface 326b. The two resilient portions 46b sleeve on the two telescopic poles 44b. One end of each of the resilient portions 46b is fixed to the fixing surface 424b, and the other end of each of the resilient portions 46b is fixed to the second side surface 326b.

When the supporting device 100b is not supporting the optical coupling lens 200, the resilient portions 46b are at rest, and the telescopic portions 444 are entirely stretched out from the receiving portions 442. In other words, the resilient portions 46b are not under tension nor under compression.

When the optical coupling lens 200 is to be supported by the supporting device 100b, first, an external force is applied to the second contacting member 30b. The external force moves the second contacting member 30b along the telescopic poles 44b toward the stationary portion 42b. Thus, a space for easily placing the optical coupling lens 200 in the supporting recess 140b is generated. In this situation, the resilient portions 46b are compressed, and the telescopic portions 444 are partially received in the receiving portions 442. Second, the optical coupling lens 200 is placed in the supporting recess 140b. In detail, the protrusion 144b engages in the receiving recess 520, and the horizontal bottom surface of the receiving recess 520 contacts the horizontal top surface of the protrusion 144b. The first sidewall 54 contacts the first contacting surface 24b. Third, the external force is released, and the resilient portions 46b pull the second contacting member 30b towards and contact with the optical coupling lens 200. In particular, the second contacting surface 342b makes contact with the second sidewall 56. Thereby, the optical coupling lens 200 is fixedly supported on the platform 10b, and the housing 50 is perpendicular to the platform 10b.

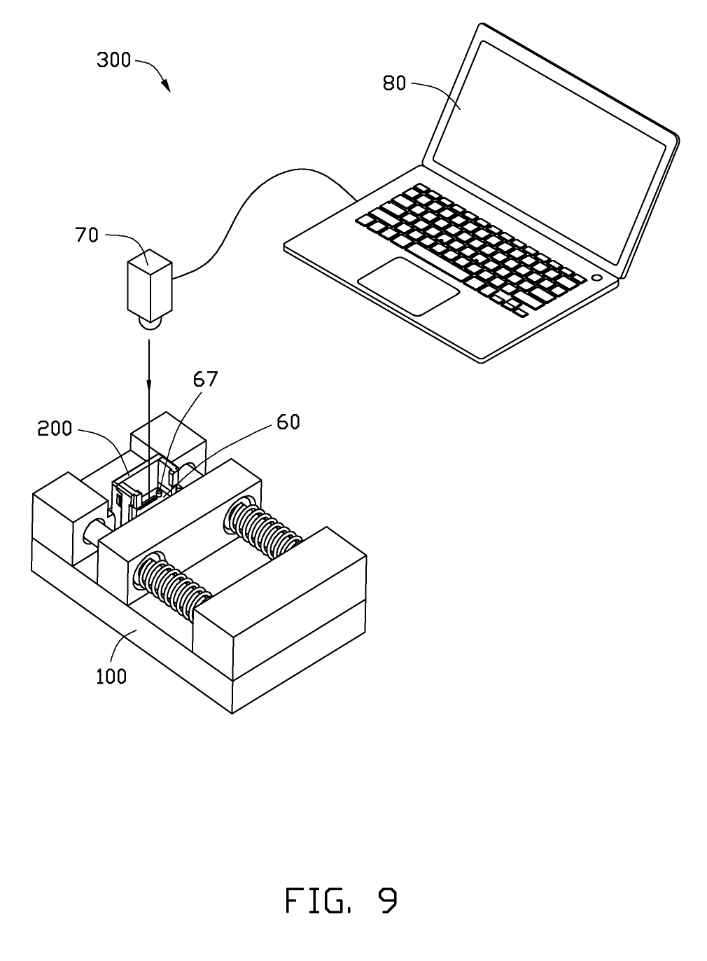

Referring to FIGS. 5-6 and 9, a system 300 for detecting the optical coupling lens 200 includes an image capturing device 70, an analyzing device 80, and the supporting device 100 of the first embodiment. The image capturing device 70 is arranged above the optical coupling lens 200 and aligned with the coupling surface 62. An optical axis of the image capturing device 700 is perpendicular to the coupling surface 62. The image capturing device 70 is configured for capturing an image which includes the coupling surface 62, the posts 68, and the optical lenses 67. The analyzing device 80 analyzes the image to obtain the location of the optical lenses 67 relative to the posts 68, and to compare the location with a predetermined location of the optical lenses 67 relative to the posts 68, to thus determine whether or not the optical coupling degree between the second optical lenses 69 and the first optical lenses 67 satisfies a predetermined range, according to the comparison. If the location is the predetermined location, the optical coupling degree between the second optical lens 69 and the first optical lenses 67 satisfy the predetermined range. If the location is not the predetermined location, the optical coupling degree between the second optical lens 69 and the first optical lenses 67 does not satisfy the predetermined range.

The system 300 may use either the supporting device 100a of the second embodiment or the support device 100b of the third embodiment.

Advantages of the supporting device 100a of the second embodiment, the supporting device 100b of the third embodiment, and the system 300 of the fourth embodiment, are similar to those of only the support device 100 of the first embodiment. In addition, the supporting blocks 14 in the supporting device 100, in the supporting device 100b, and in the system 300 are made of acrylic material. If a light source is placed under the platform 10 facing the supporting blocks 14, the image capturing device 70 achieves a greater quality of image. Thereby, the test accuracy is further increased.

Even though numerous characteristics and advantages of the present embodiments have been set fourth in the foregoing description, together with details of the structures and functions of the embodiments, the disclosure is illustrative only, and changes may be made in details, especially in the matters of shape, size, and arrangement of parts within the principles of the disclosure to the full extent indicated by the broad general meaning of the terms in which the appended claims are expressed.

What is claimed is:

1. A supporting device for supporting an optical coupling lens comprising:
a platform defining a supporting recess and comprising a bottom, a first inner side surface, and a second inner side surface in the supporting recess, the first inner side surface and the second inner side surface perpendicularly extending from the bottom and parallel to each other, the supporting recess configured to supporting the optical coupling lens;
a first contacting member fixedly mounted on the platform, the first contacting member being adjacent to the first inner side surface for contacting a first sidewall of the optical coupling lens;
a second contacting member moveably mounted on the platform and adjacent to the second side surface; and
a pressing member positioned on the platform and configured to press the second contacting member to tightly contact a second sidewall of the optical coupling lens.

2. The supporting device as claimed in claim 1, wherein the optical coupling lens further comprises a bottom wall perpendicularly connecting the first sidewall and the second sidewall, a receiving recess is defined in the bottom wall, the platform further comprises a protrusion extending from the bottom, and the protrusion engages in the receiving recess.

3. The supporting device as claimed in claim 2, wherein a bottom surface of the receiving recess is horizontally oriented, and the top surface of the protrusion is horizontally oriented.

4. The supporting device as claimed in claim 1, wherein the platform is a plate and comprises an upper surface and a lower surface opposite to the upper surface, the supporting recess is defined in the upper surface, and the first contacting member, the second contacting member, and the pressing member are positioned on the upper surface.

5. The supporting device as claimed in claim 1, wherein the platform comprises a main body and a support block, the main body defines a through hole, the support block is fixedly mounted in the through hole, and the supporting recess is defined in the support block.

6. The supporting device as claimed in claim 5, wherein the main body comprises an upper surface and a lower surface opposite to the upper surface, the first contacting member, the second contacting member, and the pressing member are positioned on the upper surface, the support block comprises a supporting surface coplanar with the upper surface, and the supporting recess is defined in the supporting surface.

7. The supporting device as claimed in claim 6, wherein the supporting block is made of acrylic material.

8. The supporting device as claimed in claim 6, wherein the first contacting member comprises a first bottom surface, a first contacting surface, and two connecting surfaces, the first bottom surface contacts the upper surface, the first contacting surface perpendicularly extends from the first bottom surface and contacts the first sidewall, the two connecting surfaces are arranged at opposite sides of the first contacting surfaces, and the first contacting surface is recessed relative to the two connecting surfaces.

9. The supporting device as claimed in claim 8, wherein the second contacting member comprises a body portion and a contacting portion, the body portion comprises a second bottom surface, a first side surface perpendicular to the second bottom surface, and a second side surface parallel to the first side surface, the first side surface is nearer to the second inner side surface than the second side surface, the contacting portion extends from the first side surface and has a second contacting surface, and the second contacting surface contacts the second sidewall.

10. The supporting device as claimed in claim 9, wherein the pressing member comprises a stationary portion, two guide poles, and two resilient portions, the stationary portion is fixedly mounted on the upper surface, the stationary portion and the first contacting member are positioned at opposite sides of the second contacting member, one end of each of the guide poles is fixed to the stationary portion, and the other end of each of the guide poles passes through the second contacting member and connect to the first contacting member, the second contacting member being slidable along the guide poles, one end of each of the resilient portions is fixed to the stationary portion, and the other end of each of the resilient portions is fixed to the second contacting member.

11. The supporting device as claimed in claim 9, wherein the pressing member comprises a stationary portion, two telescopic poles, and two resilient portions, the stationary portion is fixedly mounted on the upper surface, the stationary portion and the first contacting member are positioned at opposite sides of the second contacting member, one end of each of the telescopic poles is fixed to the stationary portion, and the other end of each of the telescopic poles is fixed to the second side surface, one end of each of the resilient portions is fixed to the stationary portion, and the other end of each of the resilient portions is fixed to the second side surface.

12. The supporting device as claimed in claim 11, wherein each of the telescopic poles comprise a receiving portion and a telescopic portion, and the telescopic portion is telescopically received in the receiving portion.

13. A system for detecting an optical coupling lens, comprising:
a supporting device comprising:
a platform defining a supporting recess and comprising a bottom, a first inner side surface, and a second inner side surface in the supporting recess, the first inner side surface and the second inner side surface perpendicularly extending from the bottom and parallel to each other, the supporting recess configured to supporting the optical coupling lens;
a first contacting member fixedly mounted on the platform, the first contacting member being adjacent to the first inner side surface for contacting a first sidewall of the optical coupling lens;
a second contacting member moveably mounted on the platform and adjacent to the second side surface; and
a pressing member positioned on the platform and configured to press the second contacting member to tightly contact a second sidewall of the optical coupling lens;
an image capturing device configured to capture an image including the optical coupling lens; and
an analyzing device configured to analyze optical coupling degree of the optical coupling lens according to the image.

14. The system as claimed in claim 13, wherein the optical coupling lens further comprise a coupling surface parallel to the bottom wall, two posts extending from the coupling surface, and a number of optical lenses, the coupling surface defines a groove between the posts, the optical lenses formed in the groove, the image comprises the coupling surface, the optical lenses, and the posts, and the analyzing device is configured to analyze the image to obtain the location of the optical lenses relative to the posts, and to compare the location with a predetermined location of the optical lenses relative to the posts.
